(19) United States
(12) Patent Application Publication
(10) Pub. No.: US 2004/0203708 A1
(43) Pub. Date: Oct. 14, 2004

(54) Method and apparatus for video encoding in wireless devices

(76) Inventors: Moinul H. Khan, Austin, TX (US); Priya Vaidya, Belchertown, MA (US)

Correspondence Address: FISH & RICHARDSON, PC, 12390 EL CAMINO REAL, SAN DIEGO, CA, 92130-2081, US

(21) Appl. No.: 10/281,089

(22) Filed: Oct. 25, 2002

(51) Int. Cl. H04Q 7/20

(52) U.S. Cl. 455/422.1; 455/445

(57) ABSTRACT

In an embodiment, a mobile device may delegate a portion of a partitionable operation, such as a video compression operation, to a network device in order to conserve power and/or computational resources.

### BACKGROUND

Mobile handheld computing devices, such as Personal Digital Assistants (PDAs), may be designed to handle video applications. Such a mobile device may be used to transmit, receive, and play video files or transmit and receive video and audio streams for a video teleconference with another mobile user.

The mobile device may include a video codec (coder/decoder) to encode video data from a digital camera to transmit over a wireless network, such as the Internet, and to decode compressed video data the device receives from the network. The complexity of video encoding algorithms and the high performance requirements of digital video compression techniques may pose a challenge to the design of video-capable mobile devices, which may have constraints on power consumption and computational performance due to their relatively small size.

### BRIEF DESCRIPTION OF THE DRAWINGS

FIG. 1 is a block diagram of a networked computer system including a mobile device.

FIG. 2 is a block diagram of the encoding sections of a mobile device and a base station.

FIG. 3 is a flowchart describing a partitioned encoding operation.

FIG. 4 is a flowchart describing a frame update operation.

FIG. 5 is a block diagram for a partitioned speech-to-text conversion operation.

### DETAILED DESCRIPTION

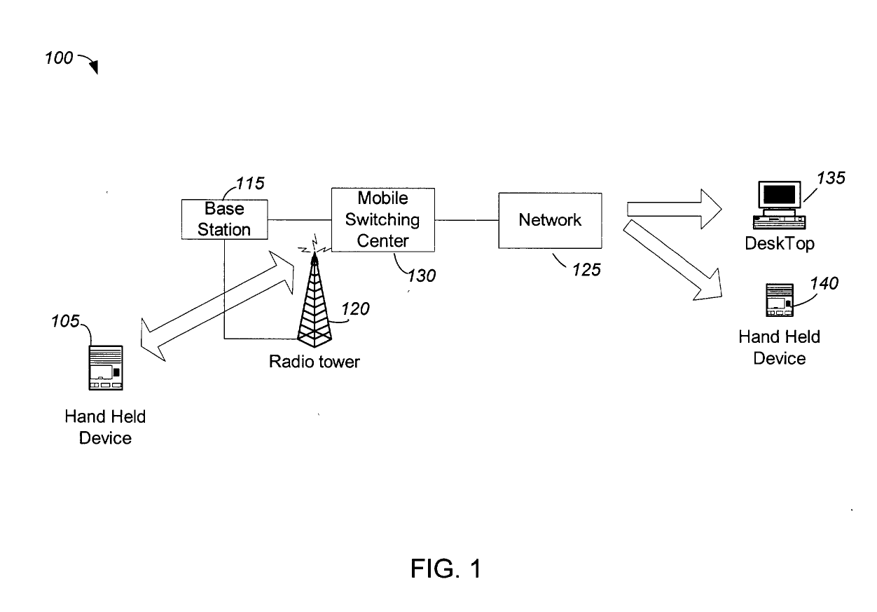

FIG. 1 illustrates a networked computer system 100. The network 100 may include a mobile device 105. The mobile device may be a mobile unit such as a Personal Digital Assistant (PDA) or mobile phone. The mobile device may include a transceiver to transmit and receive data over a wireless link 110 to a base station 115, e.g., via a radio tower 120 or other type of antenna. The base station may communicate this data to a network 125, e.g., the Internet, via a mobile switching station 130. The data may be routed through the network and delivered to a receiving station, such as a desktop personal computer (PC) 135 or another mobile device 140.

The mobile device 140 may operate in different modes. In a first operating mode, the mobile device may handle encoding and decoding of digital video data received from a digital camera in the device or received via a wireless or mobile network. In another, power saving mode, a portion of the computational load for encoding digital video data may be delegated to the base station 115 or to another network device, such as the mobile switching center 130, an active service point, or a mobile agent in the network. This redistribution of the computational load may reduce the workload and power consumption in the mobile device 140.

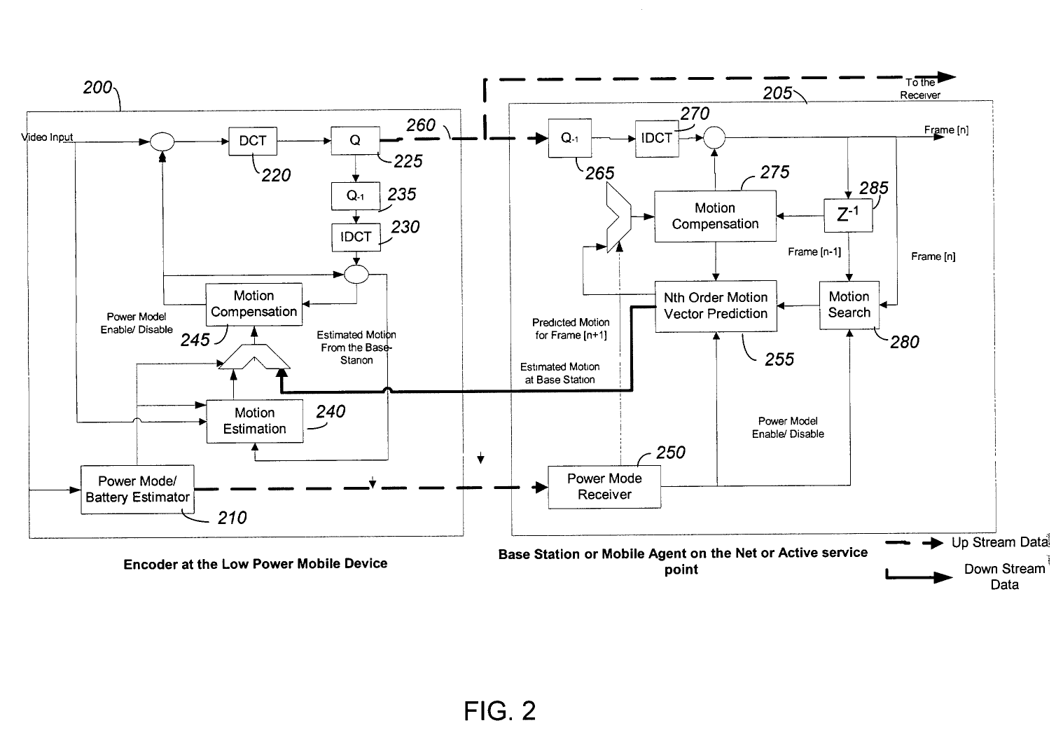

FIG. 2 illustrates an encoder 200 for a mobile device according to an embodiment. A power mode selector 210 in the encoder 200 may be used to select between the operating modes. The power mode selector 210 may select the power saving mode when, for example, computational resources become available in the base station and the mobile device is low on battery life or otherwise wants to conserve power.

The encoder 200 may receive an uncompressed video signal representing image frames generated by the digital camera in the mobile device. The video signal may be fed through an encode path which may include a Discrete Cosine Transform (DCT) unit 220 and a quantizer 225. The DCT unit 225 may be used to remove spatial correlation existing among adjacent pixels in order to enable a more efficient entropy coding. The quantizer 225 may perform a quantization process, which may utilize DCT coefficients generated by the DCT unit to remove subjective redundancy and to control the compression factor.

The video signal may be fed back through a decode path including an inverse DCT (IDCT) unit 230 and an inverse quantizer 235 in order to reverse the effects of the encode path. The video signal from the decode path may be provided to a motion estimation unit 240 and a motion compensation unit 245 which may produce a compressed video signal.

Digital video compression may utilize the redundancy between consecutive frames to reduce the amount of data which needs to be sent to a decoder in order to reproduce a frame. Changes between frames may be described by a set of motion vectors. A motion vector may be a two-dimensional vector, which provides an offset from the coordinate position in a current frame to the coordinates in a reference frame. The motion estimation unit 240 may be used to find the motion vectors pointing to a best prediction block in a reference frame or field. The motion estimation unit 240 may then output a set of motion vectors indicating how blocks in the frame have moved from the previous frame to the current frame.

In some cases, the current frame may not be captured efficiently by reshuffling the blocks from the previous frame, for example, when new picture elements are introduced into the image. This may result in errors in the estimated frame described by the set of motion vectors to be sent to the decoder at the receiving unit. The motion compensation unit 245 may compare the estimated frame to the uncompressed frame from the mobile device's camera to determine such errors. The encoder 200 may send information describing these errors to the receiving unit along with the motion vectors for a frame so that the decoder may more accurately decode the frame. The encoded frame information including the motion vectors and error information may be transmitted to the receiving unit via the base station 115.

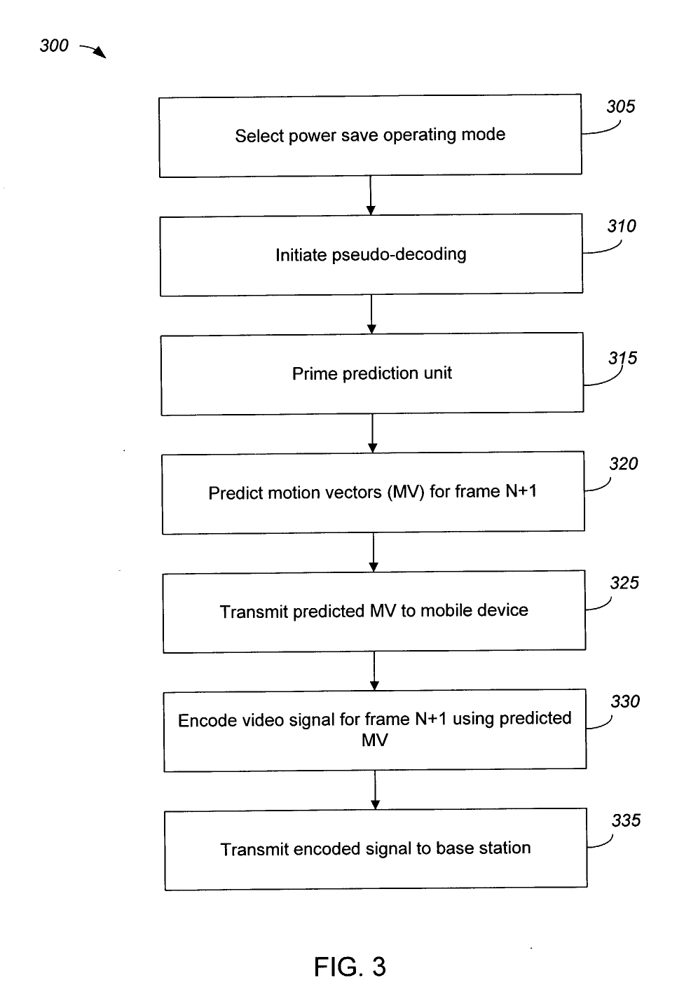

FIG. 3 illustrates a partitioned encoding operation 300 according to an embodiment. The base station may include an encoder 205 which may handle the motion estimation portion of an encoding operation while the mobile device is in the power saving operating mode. The power mode selector 210 may send a signal to a power mode receiver 250 in the base station encoder 205. The signal may indicate that the mobile device is preparing to enter the power saving operating mode (block 305). In alternative embodiments, the encoder 205 and/or the power mode receiver 245 may be placed in network devices other than the base station, or in a mobile agent in the network.

In response to the signal, the base station encoder 205 may initiate a pseudo-decoding process to support the mobile device's power saving operating mode (block 310). In personal video communication applications, such as hand-held video conferencing, the motion vectors between the successive frames may behave as a combination of a short-term memory and a long-term memory random process over time and space. The base station encoder 205 may include an Nth order motion prediction unit 255 which uses this property to predict the motion vectors of future frames. While decoding a frame N, the prediction unit 255 may predict the motion vectors for a frame N+1 based on frames N, N−1, N−2, . . . and N−k, for a k^{th} order prediction mechanism (block 320). The prediction mechanism may be, for example, a spatio-temporal prediction mechanism or a space time adaptive processing (STAP)-based algorithm for predicting the motion vectors for the future frames.

The predicted motion vectors for frame N+1 may be transmitted back to the mobile device 105 (block 325). The mobile device encoder 200 may bypass the motion estimation unit 240 in the mobile device and use the predicted motion vectors for frame N+1 from the base station 115 to encode the video signal (block 330) to transmit to the receiver (block 335). For example, the motion compensation unit 245 may compare the predicted frame N+1 with the uncompressed frame N+1 generated by the camera in the mobile device and transmit any error information along with the set of motion vectors in the encoded video signal.

Since the prediction unit may use k frames to predict frame N+1, the system may need to be primed with k frames at the beginning of the power saving mode (block 315). During this time, the motion estimation unit 240 in the mobile device may be active. The duration of the priming period may depend on the size of k.

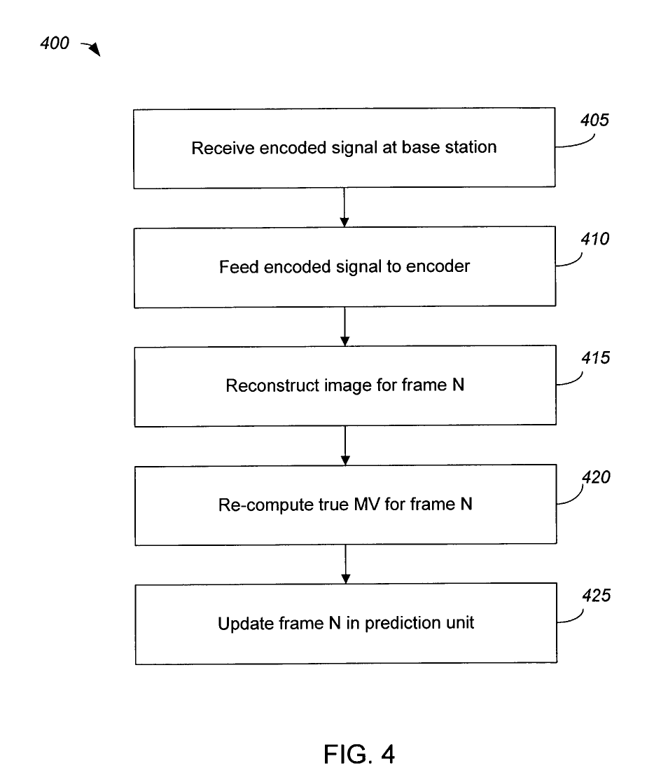

To prevent prediction errors from propagating over successive frames, the encoder 205 may include a frame update chain to re-compute the true motion vectors for received frames and provide this updated frame information to the prediction unit 255 for use in future motion vector predictions. FIG. 4 illustrates a frame update operation 400 according to an embodiment. The encoded bit stream 260 received by the base station (block 405) may be forwarded to the receiver and fed back to the encoder 205 (block 410). The encoded video signal may be decoded in a decode chain including an inverse quantizer 265 and an IDCT 270. A motion compensation unit 275 may use the predicted motion vectors and error information for a received frame N to reconstruct the image for frame N (block 415). A motion search unit 280 may perform a motion search on frame N using a reconstructed frame N−1 from a delay unit 285 to re-compute the true motion vector for frame N (block 420). The updated motion vectors for frame N may be input to the prediction unit 255 to be used in future motion vector predictions (block 425).

Although the power saving mode has been described for use in a partitioned video encoding operation, partitioned computational may be used in other applications. For example, some video encoding algorithms may include object analysis, in which a distinct object or region of interest (ROI), may be analyzed. Once the analysis has been performed, the same object may be tracked in consecutive scenes. Such object analysis operations, which may be computational expensive, may be performed by the base station on behalf of the mobile device.

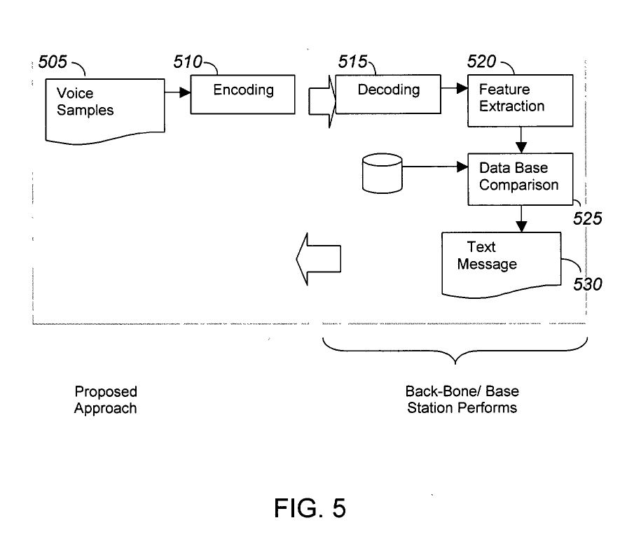

Voice recognition and speech-to-text and text-to-speech applications for mobile devices may also be computationally expensive, especially if the vocabulary is large and thee algorithms include extensive semantic processing. Voice samples taken from the voice of the mobile device user (block 505) may be encoded (block 510) and sent to the base station for further analysis, as shown in FIG. 5. The encoded information may be decoded at the base station (block 515) and a feature extraction operation (block 520), such as noise suppression or speech analysis, may be performed. The extracted features may be compared against the contents of a database (block 525) and converted to a text message (block 530), which may be sent back to the mobile device as a text message. For text-to-speech applications, the mobile device may transfer a text message to the base station, and the base station may convert the text message to speech and send the speech information back to the mobile device, or forward the information to an intended user.

A number of embodiments have been described. Nevertheless, it will be understood that various modifications may be made without departing from the spirit and scope of the invention. For example, blocks in the flowcharts may be skipped or performed out of order and still produce desirable results. Accordingly, other embodiments are within the scope of the following claims.

1. A method comprising:
receiving upstream data generated by a mobile device performing a partitionable operation;
receiving a mode select signal from the mobile device;
performing a portion of the partitionable operation; and
transmitting data generated from said portion to the mobile device.

2. The method of claim 1, wherein said receiving upstream data comprises receiving compressed digital video information.

3. The method of claim 1, wherein said transmitting data comprises transmitting motion vector information.

4. The method of claim 1, further comprising forwarding the upstream data to a receiving device via a network.

5. The method of claim 1, wherein said receiving upstream data comprises receiving compressed voice sample information.

6. The method of claim 5, wherein said transmitting data comprises transmitting a text message generated from the compressed voice sample information.

7. A method comprising:
generating a first type of information in a partitionable operation having a first portion and a second portion;
transmitting said first type of information to a network device;
delegating the first portion of said partitionable operation to the network device;
receiving a second type of information from said network device in response to said delegating;
generating the first type of information in the second portion of said partitionable operation using the second type of information from the network device.

8. The method of claim 7, wherein said generating the first type of information comprises generating compressed digital video information.

9. The method of claim 8, wherein said generating said second type of information comprises generating motion vectors.

10. The method of claim 7, wherein said transmitting comprises transmitting said first type of information from a mobile device over a wireless channel.

11. The method of claim 7, further comprising transmitting a power saving mode signal to the network device, and performing said delegating the first partitioned operation to the network device in response to said signal.

12. Apparatus comprising:
a transceiver operative to receive data from a mobile device and forward said data to a receiving device via a network;
a mode selector operative to switch from a first operating mode to a second operating mode in response to receiving a signal from the mobile device; and
a logic unit operative to perform a first portion of a partitionable operation using said received data in the second operating mode; and
a downstream transmitter operative to transmit data generated by said first portion of the partitionable operation to the mobile device in the second operating mode.

13. The apparatus of claim 12, wherein said partitionable operation comprises a video compression operation.

14. The apparatus of claim 13, wherein said first portion of the video compression operation comprises a motion estimation portion of the video compression operation.

15. The apparatus of claim 12, wherein said logic unit comprises:
a frame memory operative to store a plurality of frames received from the mobile device; and
a motion vector prediction unit operative to predict a motion vector for a future frame using data from said plurality of frames.

16. The apparatus of claim 15, wherein said logic unit comprises a frame reconstruction unit operative to reconstruct a frame from said received data from the mobile device, and to update said frame memory with said reconstructed frame.

17. The apparatus of claim 12, wherein said network device comprises a base station.

18. Apparatus comprising:
a first logic unit operative to perform a first portion of an operation using a first type of information;
a second logic unit operative to generate said first type of information;
a mode selector operative to select between a first operating mode and a second operating mode;
a receiver operative to receive data from a network device in response to said mode selector selecting the second mode, said data including said first type of information; and
a switching unit operative to provide data from the second logic unit to the first logic unit in the first operating mode and to provide data from the receiver in the second operating mode.

19. The apparatus of claim 18, wherein said operation comprises a video compression operation.

20. The apparatus of claim 18, wherein the first logic unit comprises a motion compensation unit.

21. The apparatus of claim 18, wherein the second logic unit comprises a motion estimation unit.

22. The apparatus of claim 18, wherein the second operating mode comprises a power saving operating mode.

23. The apparatus of claim 18, further comprising a transmitter operative to transmit a signal to the network device in response to the mode selector selecting the second operating mode.

24. The apparatus of claim 18, further comprising a battery having a power level,
wherein the mode selector comprises a battery estimator operative to determine a power level of the battery, and
wherein the mode selector is operative to select the second mode in response to the battery estimator determining said power level is below a minimum threshold power level.

25. The apparatus of claim 18, wherein said apparatus comprises a personal digital assistant (PDA).

26. An article comprising a medium including machine-readable instructions, the instructions operative to cause a machine to:
receive upstream data generated by a mobile device performing a partitionable operation;
receive a mode select signal from the mobile device;
perform a portion of the partitionable operation; and
transmit data generated from said portion to the mobile device.

27. The article of claim 26, wherein the instructions operative to cause the machine to receive upstream data comprise instructions operative to cause the machine to receive compressed digital video information.

28. An article comprising a medium including machine-readable instructions, the instructions operative to cause a machine to:
generate a first type of information in a partitionable operation having a first portion and a second portion;
transmit said first type of information to a network device;
delegate the first portion of said partitionable operation to the network device;
receive a second type of information from said network device in response to said delegating; and
generate the first type of information in the second portion of said partitionable operation using the second type of information from the network device.

29. The article of claim 28, wherein the instructions operative to cause the machine to generate the first type of information comprise instructions operative to cause the machine to generate compressed digital video information.
